(19) United States
(12) Patent Application Publication
(10) Pub. No.: US 2005/0288417 A1
(43) Pub. Date: Dec. 29, 2005

(54) Chlorine-resistant elastane fibers protected against colour change

(75) Inventors: Stephan Hutte, Leverkusen (DE); Hans-Josef Behrens, Dormagen (DE); Darius Naroska, Dormagen (DE)

Correspondence Address: Norris, McLaughlin & Marcus, P.A., 18th Floor, 875 Third Avenue, New York, NY, 10022, US

(73) Assignee: Dorlastan Fibers GmbH, Dormagen (DE)

(21) Appl. No.: 11/151,380

(22) Filed: Jun. 13, 2005

(30) Foreign Application Priority Data
Jun. 17, 2004 (DE) 1020040292744

(51) Int. Cl. C08K 3/22

(52) U.S. Cl. 524/436; 524/437

(57) ABSTRACT

The invention relates to elastic fibers of polyurethaneurea, which are not discoloured by operating steps required to produce loop-formingly knitted fabrics or textiles, for example heat setting or moulding, and can be used in aqueous chlorinated environments, such as swimming pools for example, for swimwear, and to a process for their production. The polyurethaneurea fibers contain hydrotalcites coated with dialkyl sulphosuccinates.

The invention relates to elastic fibers of polyurethane, especially polyurethaneurea, which are not discoloured by operating steps required to produce textiles and can be used in aqueous chlorinated environments, such as swimming pools for example, for swimwear. The invention relates to elastic fibers of polyurethaneurea which comprise coated hydrotalcites.

As used herein, “fiber” comprehends staple fibers and/or continuous filaments which can be produced by principally known spinning operations, for example the dry-spinning process or the wet-spinning process, and also melt spinning.

Elastic fibers of polyurethaneurea are composed of long-chain synthetic polymers which are constructed, to an extent of not less than 85%, of segmented polyurethaneureas based on, for example, polyethers, polyesters and/or polycarbonates, and are well known. Elastic fibers of polyurethane can be constructed similarly to polyurethaneurea fibers. The essential difference is that diols are used for polymerization instead of amines. Yarns formed from previously identified fibers are combined with hard fibers such as polyamide or polyester or other fibers such as cotton or viscose and used to produce loop-formingly knitted fabrics which in turn are useful for textiles, including foundation garments, stockings and sportswear, examples being bathing costumes and swimming trunks. To produce loop-formingly knitted fabrics or textiles, the fibers pass through different operations and can be exposed to high temperatures of above 185° C. or 100° C. during heat setting or moulding. This thermal exposure can cause polyurethaneurea fibers to undergo an undesirable change of colour, which can compromise particularly the production of light-coloured textiles or those having high weight fractions (>10% by weight, based on the weight of the entire textile) of polyurethaneurea fibers. Furthermore, swimming pool water is for hygienic reasons frequently chlorinated to such an extent that the active chlorine content is usually between 0.5 and 3.5 ppm (parts per million) or even higher. When polyurethaneurea fibers are exposed to such an environment, this can lead to degradation or impairment of physical properties, for example the tenacity, of the fibers and thereby to premature wear and tear on the part of the textiles.

A change in the colour of polyurethaneurea fibers in the course of textile manufacture due to thermal treatment, as in the course of a heat setting or moulding operation, is commercially unacceptable, since it makes it virtually impossible to produce especially light-coloured textiles on a consistent basis. Moreover, when the textiles to be produced contain high levels of polyurethaneurea fibers, hues cannot be correctly matched for example. By contrast, a certain degree of fiber degradation due to chlorine can be tolerated without the user of the fabrics produced from these fibers being aware of the effects of chlorine. Avoidance of colour change due to, for example, thermal treatment in the course of textile manufacture is accordingly necessary especially to produce textiles in a light-coloured hue and similarly to produce textiles containing a high level of polyurethaneurea fibers, above 10% by weight for example. At the same, the fiber material shall possess good resistance to chlorine-induced degradation.

To improve chlorinated water resistance of elastic polyurethaneurea yarns for swimwear applications, polyurethaneureas have frequently been produced from polyesters as a low molecular weight mono-, di- or poly-hydroxyl-functional polymer. However, aliphatic polyesters possess a high level of biological activity. This is why polyurethaneureas produced from this polymer have the disadvantage of being readily degraded by microbes and fungi. It has further been determined that the chlorinated water resistance of polyurethaneureas based on polyesters is unsatisfactory.

A multiplicity of additives in elastane fibers have been described to improved the chlorinated water resistance of elastic polyurethaneurea fibers.

U.S. Pat. No. 6,406,788 describes the incorporation of zinc oxide in filaments of segmented polyurethaneureas for the purpose of achieving chlorine stabilization. Zinc oxide, however, has the serious disadvantage of leaching out of the filament during dyeing of the fabrics, especially under acidic conditions (pH 3 to 4). This greatly diminishes the chlorinated water resistance of the fiber. Furthermore, the zinc-containing dyehouse wastewaters kill bacteria in biological water treatment plants used to treat the wastewaters. As a consequence, the performance of such water treatment plants may suffer appreciably.

JP 59-133 248 OPI document describes improved chlorinated water resistance achieved through incorporation of hydrotalcite in filaments of segmented polyurethaneureas. As well as stabilization being achieved without use of a heavy metal, it is stated that only small amounts of dispersed hydrotalcite leach out when dyeing under acidic conditions (pH 3 to 4), so preserving good stability to chlorinated water. What has been found to be disadvantageous, however, is that hydrotalcite tends to agglomerate in polar solvents such as dimethylacetamide or dimethylformamide and even in spinning solutions for polyurethaneurea fibers. Agglomerates in spinning solutions for polyurethaneurea fibers rapidly lead to clogging of spinneret dies, so that the spinning operation has to be frequently interrupted on account of frequently breaking fibers and/or pressure build-up at the spinneret dies. Spinning such PU compositions for a prolonged period with sufficient consistency is thus not possible by this process. Moreover, such filaments can lead to an undesirable change in colour in the course of further processing into a textile due to a heat setting or moulding operation.

EP-A-558 758 OPI document describes a polyurethaneurea composition which comprises a hydrotalcite containing water of crystallization and having a fatty acid adhered thereto. The disadvantage with this composition is that when filaments produced from the polyurethaneurea composition are further processed into a textile they can lead to an undesirable change in colour due to a heat setting or moulding operation, i.e. a thermal treatment.

EP-A-843 029 patent application describes a polyurethaneurea composition and polyurethaneurea elastic fibers which result specifically therefrom and which contain hydrotalcites and/or other basic metal-aluminium hydroxy compounds each coated with polyorganosiloxane or a mixture of polyorganosiloxane and polyorganohydrosiloxane. One disadvantage with this composition is that, when the polyurethaneurea fibers described are produced in a continuous spinning operation over a prolonged period, disruptions in the spinning operation are possible and, after a few days of spinning, the thread can start to break as it is being wound up on the package. A further disadvantage with this composition is that, again, filaments produced from this polyurethaneurea composition can lead on further processing into a textile to an undesirable change in colour due to a heat setting or moulding operation, i.e. a thermal treatment.

EP 1 200 518-A1 OPI document describes a polyurethaneurea composition and polyurea fibers which result specifically therefrom and which contain hydrotalcite and a dialkyl sulphosuccinate additive which increases fiber strength. However, when filaments produced from this polyurethaneurea composition are further processed into a textile they can lead to an undesirable change in colour due to a heat setting or moulding operation, i.e. a thermal treatment.

The invention has for its object to provide a polyurethaneurea composition especially for polyurethaneurea fibers (also known as elastane fibers) which, compared with the prior art, is free of undesirable discoloration due to thermal exposure of the polyurethaneurea fibers of the kind which can occur during the heat setting or moulding in the process chain to produce the loop-formingly knitted fabrics or textiles, and possesses good resistance to chlorinated water.

We have found that this object is achieved by the invention when an effective amount of finely divided hydrotalcites coated with dialkyl sulphosuccinate is added to the polyurethaneurea fibers.

The invention accordingly provides polyurethaneurea fibers (elastane fibers) having reduced tendency to change colour during a thermal treatment and high resistance to chlorine and composed of not less than 85% of segmented polyurethaneurea, the polyurethaneurea fibers containing 0.30% to 10% by weight of finely divided hydrotalcite especially hydrotalcite of the general formula (1)
M₁₋ₓ²⁺Alₓ(OH)₂A_{x/n}ⁿ⁻.mH₂O (1)
where
M²⁺ represents magnesium,
Aⁿ⁻ is an anion of valence number n selected from OH⁻, CO₃²⁻ or silicate, especially CO₃²⁻,
0<x≦0.5 and 0<m<1,
characterized in that the hydrotalcites are coated with 1% to 15% by weight, based on the weight of the coated hydrotalcites, of a dialkyl sulphosuccinate.

The amount of dialkyl sulphosuccinate coated hydrotalcite present in fine dissipation in the polyurethaneurea fibers is in the range from 0.3% by weight to 10% by weight, preferably in the range from 0.5% by weight to 8% by weight, more preferably in the range from 1.5% by weight to 7% by weight and most preferably in the range from 2% by weight to 6% by weight, based on the weight of the polyurethaneurea fiber. The amount of hydrotalcite can be present within the elastane fibers and/or on their surface.

The hydrotalcites are especially preferably hydrotalcites as shown for example in the formulae (2) and (3):
Mg₆Al₂(OH)₁₆(A²⁻).wH₂O (2);
Mg₄Al₂(OH)₁₂(A²⁻).wH₂O (3);
A²⁻ is as defined above in connection with the formula (1) and 1≦w≦15.

Particularly preferred examples of hydrotalcites are those having the formulae (4) and (5):
Mg₆Al₂(OH)₁₆CO₃.5H₂O (4);
Mg₄Al₂(OH)₁₂CO₃.4H₂O (5).

The dialkyl sulphosuccinates described are used for coating the hydrotalcites at a level in the range from 1% to 15% by weight based on the weight of the coated hydrotalcite. Preference is given to using hydrotalcites coated with 1.5% to 12% by weight of dialkyl sulphosuccinate. Particular preference is given to using hydrotalcites coated with 2% to 8% by weight of dialkyl sulphosuccinate.

The dialkyl sulphosuccinates used are preferably dialkyl sulphosuccinates conforming to the general formula (6) 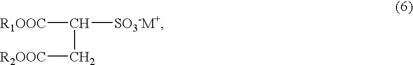
where
R₁ and R₂ are the same or different and independently represent an alkyl group having 5 to 18 carbon atoms and preferably an alkyl group having 8 carbon atoms,
R₁ and R₂ are more preferably the same and represent ethylhexyl radicals:
   —CH₂—CH(CH₂—CH₃)—CH₂—CH₂—CH₂—CH₃, and
M⁺ is Na⁺, K⁺ or NH₄⁺, preferably Na⁺.

Dialkyl sulphosuccinates can be prepared in a conventional manner as described in the literature reference C. R. Carly, Ind. Eng. Chem., Vol. 31, page 45, 1939.

Specific preferred dialkyl sulphosuccinates are sodium diisobutyl sulphosuccinate, sodium bis(n-octyl) sulphosuccinate, sodium bis(2-ethylhexyl) sulphosuccinate, sodium dihexyl sulphosuccinate, sodium diamyl sulphosuccinate and sodium dicyclohexyl sulphosuccinate.

Particular advantages result on using a dialkyl sulphosuccinate of the formula (7): 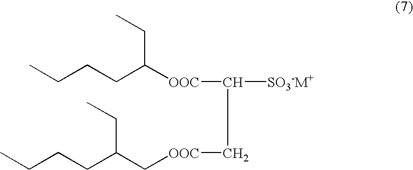
where M⁺ represents Na⁺, K⁺ or NH₄⁺, preferably Na⁺.

Sodium bis(2-ethylhexyl) sulphosuccinate is a most preferred dialkyl sulphosuccinate.

The dialkyl sulphosuccinates used to coat hydrotalcites can be used as single materials or as mixtures of plural dialkyl sulphosuccinates.

Coating of the hydrotalcites can be effected by spraying with and or admixing of the dialkyl sulphosuccinate conjointly or separately in any desired order preferably before and/or during a final grinding of the hydrotalcite. It is immaterial in this connection whether the dialkyl sulphosuccinate is mixed into moist filtercakes, pastes or slurries produced in the course of hydrotalcite production, prior to drying, or whether it is added to the dry material directly before the final grinding in a suitable manner, for example by spraying, or, in the case of steam jet drying, it is added to the steam directly before feeding into the jet mill. The dialkyl sulphosuccinate can if appropriate be converted into an emulsion before being added.

Production of the hydrotalcites as such is effected for example by processes known per se. Such processes are described for example in the EP 129 805-A1 OPI document.

Preferably, the dialkyl sulphosuccinate coated hydrotalcites are prepared from their starting compounds, for example from MgCO₃, Al₂O₃ and water, in the presence of dialkyl sulphosuccinate and a solvent such as for example water or a C₁-C₈ alcohol with subsequent drying by for example spray drying and if appropriate subsequent grinding by for example a bead mill. When dialkyl sulphosuccinate coated hydrotalcites are used as a fiber additive, it is preferable to use coated hydrotalcites having a number average diameter of not more than 5 μm, more preferably those having an average diameter of not more than 3 μm, even more preferably those having an average diameter of not more than 2 μm and yet even more preferably those having an average diameter of not more than 1 μm.

The hydrotalcites coated with dialkyl sulphosuccinate can be added to the polyurethaneurea composition at any desired stage of polyurethaneurea fiber production. For example, the hydrotalcites coated with dialkyl sulphosuccinate can be added in the form of a solution or slurry to a solution or dispersion of other fiber additives and then be mixed, or sprayed, into the polymer solution upstream of the fiber-spinning spinneret dies. Of course, the hydrotalcites coated with dialkyl sulphosuccinate can also be added separately from the polymer-spinning solution as dry powders or as a slurry in a suitable medium. The hydrotalcites coated with dialkyl sulphosuccinate can in principle also be used if appropriate to produce polyurethaneurea fibers in accordance with the procedure described above as a mixture with uncoated hydrotalcites or with hydrotalcites coated with known coating agents (for example metal fatty acids or polyorganosiloxane or a mixture of polyorganosiloxane and polyorganohydrosiloxane) provided the above-described disadvantages of known coated hydrotalcites are tolerable in the mixture.

The additization of hydrotalcites coated with dialkyl sulphosuccinates in polyurethaneurea compositions is preferably effected in accordance with the procedure described in what follows. A 20% dispersion of hydrotalcites coated with dialkyl sulphosuccinates is produced by mixing in a suitable solvent, for example dimethylacetamide. The dispersion can if appropriate be ground by means of a bead mill, for example Fryma mill model MSZ 12, Fryma-Maschinenbau GmbH. The dispersion is admixed with a polyurethaneurea spinning solution such that a 12 to 16% level (% by weight) of hydrotalcites coated with dialkyl sulphosuccinates results in the resulting dispersion. This dispersion ensures that the hydrotalcites coated with dialkyl sulphosuccinate do not sediment and are in a fine state of subdivision after storage. The number average diameter of dialkyl sulphosuccinate coated hydrotalcites in this dispersion is preferably not more than 3 μm, more preferably not more than 2 μm and most preferably not more than 1 μm.

The polyurethaneurea fibers according to the invention may contain a multiplicity of various further additives for various purposes, for example delustrants, fillers, antioxidants, dyes, staining agents, stabilizers against heat, light, UV radiation and fumes.

Examples of antioxidants, stabilizers against heat, light or UV irradiation are stabilizers from the group of sterically hindered phenols, hindered amine light stabilizers, triazines, benzophenones and benzotriazoles. Examples of pigments and delustrants are titanium dioxide, zinc oxide and barium sulphate. Examples of dyes are acidic dyes, disperse dyes and pigments dyes and optical brighteners. The stabilizers mentioned can also be used in mixtures and contain an organic or inorganic coating agent. The additives mentioned should preferably be metered in such amounts that they do not exhibit any effects contrary to the hydrotalcites coated with dialkyl sulphosuccinates.

As mentioned at the beginning, hydrotalcites will agglomerate under certain circumstances in polar solvents such as for example dimethylacetamide, dimethylformamide or dimethyl sulphoxide which are customarily employed in the dry- or wet-spinning operation to produce fibers of polyurethaneurea. This is why spinning solutions comprising incorporated hydrotalcites may, during the spinning operation, give rise to problems due to clogging of spinneret dies, resulting in a strongly rising die pressure and/or breaking of freshly formed fibers before or in the course of winding onto a package. On incorporation of dialkyl sulphosuccinate coated hydrotalcites in polyurethaneurea spinning solution in accordance with the invention no agglomeration occurs in the spinning solution and the average particle size of the hydrotalcites coated with dialkyl sulphosuccinate remains essentially unchanged. This promotes spinneret die service life and hence operating consistency and profitability in the dry or wet spinning of the invention's polyurethaneurea fibers.

The invention also provides a process for producing polyurethaneurea fibers comprising dissolving a long-chain synthetic polymer comprising not less than 85% of segmented polyurethane in an organic solvent, for example dimethylacetamide, dimethylformamide or dimethyl sulphoxide, at a fraction in the range from 20% to 50% by weight in relation to the polyurethaneurea composition and preferably at a fraction in the range from 25% to 45% by weight in relation to the polyurethaneurea composition and then spinning this solution through spinneret dies by the dry- or wet-spinning process to form filaments, characterized in that hydrotalcite coated with a dialkyl sulphosuccinate is added to the spinning solution in an amount in the range from 0.30% by weight to 10% by weight, preferably in the range from 0.5% by weight to 8% by weight, more preferably in the range from 1.5% by weight to 7% by weight and most preferably in the range from 2% by weight to 6% by weight, based on the weight of the polyurethaneurea fiber, and is distributed within the filaments and if appropriate additionally on the filament surface.

When less than 0.30% by weight of hydrotalcites coated with dialkyl sulphosuccinate is dispersed within the filament and also if appropriate additionally on the filament surface, efficacy against degradation of the polymer due to chlorine will under certain circumstances be less satisfactory.

The dispersion of significantly more than 10% by weight of hydrotalcites coated with dialkyl sulphosuccinate within the filament and also if appropriate additionally on the filament surface can lead to disadvantageous physical properties on the part of the fibers and therefore is less advisable.

The improved polyurethaneurea fibers of the invention consist of segmented polyurethanes, for example those which are based on polyethers, polyesters, polyetheresters, polycarbonates and the like. Such fibers can be produced by principally known processes, as for example by processes described in WO 94/23100-A1 or WO 98/25986-A1. In addition, the polyurethaneurea fibers can consist of thermoplastic polyurethanes whose preparation is described for example in the OPI document EP 1 379 591-A1.

Segmented polyurethanes are prepared in principle in particular from a linear homo- or copolymer having a hydroxyl group at each end of the molecule and a molecular weight in the range from 600 to 4000, for example from the group consisting of polyesterdiols, polyetherdiols, polyester amide diols, polycarbonate diols, polyacrylate diols, polythioester diols, polythioether diols, polyhydrocarbon diols or a mixture or copolymers of compounds of this group. The segmented polyurethane is further based in particular on organic diisocyanates and chain extenders having plural active hydrogen atoms, such as for example di-polyols, di- and polyamines, hydroxylamines, hydrazines, polyhydrazides, polysemicarbazides, water or a mixture thereof.

Some of these polymers are more sensitive to chlorine-induced degradation than others. Accordingly, polyurethaneurea fibers composed of a polyether-based polyurethaneurea are significantly more sensitive than polyurethaneurea fibers composed of a polyester-based polyurethaneurea. This is why particular preference is given to polyurethaneurea fibers comprising polyether-based polyurethaneureas.

Hydrotalcites coated with dialkyl sulphosuccinate are additives which do not contain heavy metal and are generally recognized as safe by toxicologists and therefore are preferred. This can be utilized to ensure that the further processing of the polyurethaneurea fibers, as by dyeing for example, does not give rise to wastewaters which would impair or destroy the functioning of a biological water treatment plant.

If, in the course of the processing of the polyurethaneurea fibers into a textile article, discolorations occur due to an undesirable colour change on the part of the polyurethaneurea fiber, the hues of the textile article are impossible to match in dyeing operations for example. Such undesirable discolorations make it difficult if not impossible to produce textile articles in light-coloured hues in particular. When hydrotalcites coated with dialkyl sulphosuccinate are incorporated into polyurethaneurea spinning solutions in accordance with the invention, then, as shown in Examples 1 and 2, the discoloration of the polyurethaneurea composition and of the polyurethaneurea fibers resulting therefrom can be prevented. The spinneret die service life and the associated operating consistency in the dry-spinning operation and the resistance to degradation of the polyurethaneurea fibers which is induced by chlorinated water remain at a high level.

The present invention further provides textile articles, especially loop-drawingly knitted, loop-formingly knitted or woven articles, produced using the polyurethaneurea fibers of the invention, preferably in admixture with synthetic hard fibers such as polyamide, polyester or polyacrylic fibers and/or with natural fibers such as wool, silk or cotton.

The invention will now be more particularly described by non-limiting examples in which all percentages are based on the total weight of fiber, unless otherwise stated.

### EXAMPLES

The examples show the colour change or yellowing of polyurethaneurea compositions suitable for producing fibers and of the resulting polyurethaneurea fibers that contain hydrotalcite coated with various agents. The polyurethaneurea compositions have been produced on the basis of polyetherdiols and contain the hydrotalcites coated with various agents as an internal additive.

Examples 1 and 2 feature the production of polyurethaneurea spinning solutions from a polyetherdiol consisting of polytetrahydrofuran (PTHF) having an average molecular weight of 2000 g/mol. The diol was blocked with methylene bis(4-phenyl diisocyanate) (MDI) in a molar ratio of 1:1.65, diluted in dimethylacetamide and then chain extended with a mixture of ethylenediamine (EDA) and diethylamine (DEA) in dimethylacetamide. The molecular weight reported for the polyether is the number average molecular weight. The polymer content of the polyurethaneurea spinning solution produced is 30% by weight.

It will be understood that the specification and examples are illustrative but not limitative of the present invention and that other embodiments within the spirit and scope of the invention will suggest themselves to these skilled in the art.

### Example 1

Hydrotalcites coated with various coating agents were dispersed in 20% strength in dimethylacetamide solvent by means of an Ultra-Turrax and subsequently incorporated into the above-described polyurethaneurea spinning solution such that the level of coated hydrotalcite based on the polymer in the polyurethaneurea spinning solution is 10% by weight.

The polyurethaneurea spinning solution admixed with hydrotalcite coated according to Table 1 was knife coated to form a film. The solvent was evaporated in a circulating air drying cabinet at a temperature of 70° C. over a period of 10 hours. The ready-produced film was 1 mm thick.

The films knife coated from the elastane solution are used to be able to more accurately test and assess the yellowing of the material for elastane fibers.

Yellowing was tested by leading the films through a stenter at a speed of 5 m/min and at a temperature of 195° C. This passage through a stenter corresponds to the processing step of hot air setting in the manufacture of textiles. The time taken for the films to pass through the stenter was 50 seconds.

The yellowing results are listed in Table 1. It is evident that only the film from the polyuethaneurea composition which contained hydrotalcite coated with sodium dioctyl sulphosuccinate shows no sign of yellowing. All the other films showed severe yellowing.

TABLE 1

| | | Coating (% by | |
|---|---|---|---|
| | | weight based | |
| Sample | Stabilizer | on stabilizer) | Yellowing |
| 1-1-comp. | Mg₆Al₂(OH)₁₆CO₃ × 5H₂O | 5% of stearic | severe |
| | | acid | |
| 1-2-comp. | Mg₆Al₂(OH)₁₆CO₃ × 5H₂O | 5% of Baysilone | severe |
| | | oil GPW 2233* | |
| 1-3-comp. | Mg₆Al₂(OH)₁₆CO₃ × 5H₂O | none | severe |
| 1-4 | Mg₆Al₂(OH)₁₆CO₃ × 5H₂O | 5% of sodium | none |
| | | dioctyl | |
| | | sulphosuccinate | |

*manufacturer: GE-Bayer Silicones

### Example 2

The polyurethaneurea spinning solution described above was admixed with the following additives via the following stock batches:

The first stock batch consisted of 55.3% by weight of dimethylacetamide (DMAC), 11.1% by weight of Cyanox® 1790 ((1,3,5-tris(4-tert-butyl-3-hydroxy-2,5-dimethylbenzyl)-1,3,5-triazine-2,4,6-(1H,3H,5H)-trione, from Cytec), 7.6% by weight of Aerosol OT® 100 (sodium bis(2-ethylhexyl) sulphosuccinate, from Cytec), 26.0% by weight of 30% strength spinning solution and 0.001% by weight of the dye Makrolex® Violet from Bayer AG. This stock batch was added to the spinning solution such that the level of Cyanox® 1790 in the ready-produced fiber was 1% by weight based on the solids content of the fiber polymer.

This spinning solution was admixed with a second stock batch consisting of 30.9% by weight of titanium dioxide type RKB 3 (from Kerr-McGee Pigments GmbH & Co. KG), 44.5% by weight of DMAC and 24.6% by weight of 30% strength spinning solution such that a titanium dioxide content of 0.20% by weight resulted in the ready-produced fiber, based on the polyurethane-urea polymer.

This polyurethaneurea spinning solution is then admixed with a third stock batch. This consisted of 5.5% by weight of Silwet® L 7607 (polyalkoxy-modified polydimethylsiloxane; viscosity: 50 mPas (at 25° C.), molecular weight 1000 g/mol, from OSI Specialties), 5.5% by weight of magnesium stearate, 45.0% by weight of DMAC and 44.0% by weight of a 30% strength spinning solution and is added such that a magnesium stearate content of 0.27% by weight, based on the solids content of the polyurethane-urea polymer, resulted.

This spinning solution was admixed with a fourth stock batch consisting of 13.8% by weight of the coated hydrotalcites reported in Table 2, 55.2% by weight of dimethylacetamide and 31.0% by weight of 30% strength spinning solution such that 3.0% by weight of coated hydrotalcites reported in Table 2 resulted in the ready-produced elastane fiber, based on the polyurethane-urea polymer.

The ready-produced spinning solutions were dry spun through spinneret dies in a typical spinning apparatus to produce filaments having a linear density of 15 dtex, three individual filaments at a time being converged together to form coalescent filament yarns having a total linear density of 44 dtex. The spin finish, consisting of polydimethylsiloxane having a viscosity of 5 cSt/25° C., was applied via an applicator roll at add-on of 4.0% by weight on weight of fiber. The fiber was subsequently wound up at a speed of 900 m/min.

Yellowing was tested by machine knitting the filaments into a tube which was subsequently led through a stenter at a speed of 5 m/min and a temperature of 195° C. The time taken for the knit tubes to pass through the stenter was 50 seconds.

The yellowing results are listed in Table 2. It is evident that only the filament from the polyuethaneurea composition which contained hydrotalcite coated with sodium dioctyl sulphosuccinate shows no sign of yellowing. All the other filaments showed severe yellowing.

TABLE 2

| | | Coating (% by | |
|---|---|---|---|
| | | weight based | |
| Sample | Stabilizer | on stabilizer) | Yellowing |
| 2-1-comp. | Mg₆Al₂(OH)₁₆CO₃ × 5H₂O | 5% of stearic | yellowed |
| | | acid | |
| 2-2-comp. | Mg₆Al₂(OH)₁₆CO₃ × 5H₂O | 5% of Baysilone | yellowed |
| | | oil GPW 2233* | |
| 2-3-comp. | Mg₆Al₂(OH)₁₆CO₃ × 5H₂O | none | yellowed |
| 2-4 | Mg₆Al₂(OH)₁₆CO₃ × 5H₂O | 5% of sodium | no |
| | | dioctyl | discoloration |
| | | sulphosuccinate | |

*manufacturer: GE-Bayer Silicones

The long service lives of the spinneret dies and the associated operating consistency in the dry-spinning operation was demonstrated in a 14 day spinning trial. During this period, 5.0% by weight of hydrotalcite coated with dialkyl sulphosuccinate based on the ready-produced elastane fiber were incorporated. There was no disruption of the spinning operation due to, for example, an agglomeration of the dialkyl sulphosuccinate coated hydrotalcite with the possible consequences of a build-up of pressure upstream of the filter in the spinneret die or of threadline snaps in the spinning operation. The resistance of the polyurethaneurea fibers thus produced to degradation induced by chlorinated water remained at a high level.

1. Polyurethaneurea fiber having reduced tendency to change colour during a thermal treatment and high resistance to chlorine and composed of not less than 85% of segmented polyurethaneurea, the polyurethaneurea fiber containing 0.30% to 10% by weight of finely divided hydrotalcite especially hydrotalcite of the general formula (1).
M₁₋ₓ²⁺Alₓ(OH)₂A_{x/n}ⁿ⁻.mH₂O (1)
where
M²⁺ represents magnesium,
Aⁿ⁻ is an anion of valence number n selected from OH⁻, CO₃²⁻ or silicate, especially CO₃²⁻,
0<x≦0.5 and 0<m<1,
wherein the hydrotalcites are coated with 1% to 15% by weight, based on the weight of the coated hydrotalcites, of a dialkyl sulphosuccinate.

2. Polyurethaneurea fibers according to claim 1, wherein said amount of dialkyl sulphosuccinate coated hydrotalcite present in fine dissipation in the polyurethaneurea fibers is in the range from 0.5% by weight to 8% by weight, based on the weight of the fiber.

3. Polyurethaneurea fiber according to claim 1, wherein said hydrotalcites are hydrotalcites of the formulae (2) or (3):
Mg₆Al₂(OH)₁₆(A²⁻).wH₂O (2);
Mg₄Al₂(OH)₁₂(A²⁻).wH₂O (3);
in each of which A²⁻ is as defined above in connection with the formula (1) and 1≦w≦15:

4. Polyurethaneurea fiber according to claim 3, wherin said hydrotalcites are hydrotalcites of the formula (4) or (5):
Mg₆Al₂(OH)₁₆CO₃.5H₂O (4);
Mg₄Al₂(OH)₁₂CO₃.4H₂O (5).

5. Polyurethaneurea fiber according to claims 1, wherein said dialkyl sulphosuccinate is used to coat the hydrotalcites at a level in the range from 1% to 15% by weight based on the weight of the coated hydrotalcite.

6. Polyurethaneurea fiber according to claims 1, wherein said dialkyl sulphosuccinate is a dialkyl sulphosuccinate conforming to the general formula (6) 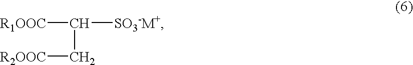
where R₁ and R₂ are the same or different and independently represent an alkyl group having 5 to 18 carbon atoms and preferably an alkyl group having 8 carbon atoms,
and R₁ and R₂ are more preferably the same and represent ethylhexyl radicals:
—CH₂—CH(CH₂—CH₃)—CH₂—CH₂—CH₂—CH₃, and
M+is Na⁺, K⁺ or NH₄⁺, preferably Na⁺.

7. Polyurethaneurea fiber according to claim 6, wherein said dialkyl sulphosuccinate included for coating is sodium diisobutyl sulphosuccinate, sodium bis(n-octyl) sulphosuccinate, sodium bis(2-ethylhexyl) sulphosuccinate, sodium dihexyl sulphosuccinate, sodium diamyl sulphosuccinate or sodium dicyclohexyl sulphosuccinate.

8. Polyurethaneurea fiber according to claim 7, wherein said the dialkyl sulphosuccinate present is 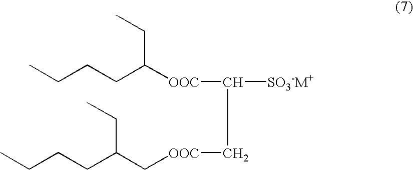
where M⁺ represents Na⁺, K⁺ or NH₄⁺, preferably Na⁺, and
preferably sodium bis(2-ethylhexyl) sulphosuccinate.

9. Polyurethaneurea fiber according to claim 1, wherein said hydrotalcite coated with dialkyl sulphosuccinate has a number average diameter of not more than 5 μm, more preferably of not more than 3 μm, even more preferably of not more than 2 μm and yet even more preferably of not more than 1 μm.

10. Process for producing polyurethaneurea fibers according to claim 1 comprising dissolving a long-chain synthetic polymer comprising not less than 85% of segmented polyurethane in an organic solvent, for example dimethylacetamide, dimethylformamide or dimethyl sulphoxide, at a fraction in the range from 20% to 50% by weight in relation to the polyurethaneurea composition and then spinning this solution through spinneret dies by the dry- or wet-spinning process to form filaments, wherein said hydrotalcite coated with a dialkyl sulphosuccinate is added to the spinning solution in an amount in the range from 0.30% by weight to 10% by weight, based on the weight of the polyurethaneurea fiber, and is distributed within the filaments and if appropriate additionally on the filament surface.

11. Textile articles, especially loop-drawingly knitted, loop-formingly knitted or woven articles, produced using the polyurethaneurea fibers according to claim 1, preferably in admixture with synthetic hard fibers and/or natural fibers.

12. Textile articles according to claim 11, wherein said synthetic hard fibers are polyamide, polyester or polyacrylic fibers and said natural fibers are wool, silk or cotton.
